(19) United States
(12) Patent Application Publication
(10) Pub. No.: US 2008/0111886 A1
(43) Pub. Date: May 15, 2008

(54) IMAGE DISPLAY DEVICE AND METHOD THEREOF

(75) Inventor: Young-jai Bai, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD, Suwon-si (KR)

(21) Appl. No.: 11/755,263

(22) Filed: May 30, 2007

(30) Foreign Application Priority Data
Nov. 13, 2006 (KR) 2006-111442

(51) Int. Cl. H04N 3/20

(52) U.S. Cl. 348/173

(57) ABSTRACT

An image display device capable of preventing screen burning or residual image phenomena is provided. The image display device includes a display which displays an image according to preset pixel output characteristics; a motion detection unit which detects motion of the displayed image; and an output controller which adjusts the pixel output characteristics of pixels corresponding to a still image if at least one portion of the image is determined to be a still image, based on the detection result of the motion detection unit. Therefore, screen burning or residual image phenomena can be effectively reduced.

### CROSS-REFERENCE TO RELATED APPLICATIONS

This application claims priority from Korean Patent Application No. 10-2006-0111442, filed on Nov. 13, 2006 in the Korean Intellectual Property Office, the disclosure of which is incorporated herein by reference in its entirety.

### BACKGROUND OF THE INVENTION

1. Field of the Invention

Apparatuses and methods consistent with the present invention relate to displaying an image, and more particularly, to displaying an image in which an image motion is detected and pixel output characteristics are adjusted according to the detection result, so that display burning or residual image phenomena can be prevented.

2. Description of the Related Art

Recently, various types of display devices have become developed and widely distributed as alternatives to cathode ray tube (CRT) display devices as a result of the development of digital technologies. Newly developed display devices are relatively lightweight and are easy to configure, but have a larger screen size and a thinner thickness than CRT display devices. Specifically, display devices using liquid crystal displays (LCDs) or plasma display panels (PDPs) are now in the limelight.

However, if such display devices display a still image for more than a predetermined period of time, pixels of a portion on which the still image is displayed may overheat, causing burning or residual image phenomena. In other words, if the still image is displayed for a prolonged period, the lifetime of pixels constituting the still image may be reduced compared to other pixels surrounding the image. Accordingly, if the still image is converted to another image, a residual image may remain on the screen permanently, resulting in a deterioration in the image quality.

In the conventional art, flat panel display devices generally have a residual image eliminating function to remove the above-described residual image phenomenon. The term “residual image eliminating function” means a function to periodically shift the still image left or right, up or down, so that the pixels constituting the still image are not fixed in position. For example, the still image may be shifted by one pixel every minute, and the distance of movement in one direction may be limited to within about 5 mm. In this way, pixels are shifted to prevent damage of the fluorescent film or a residual image appearing on a still image, such as a broadcasting station logo.

Display devices are now used in various places for additional purposes other than the original purpose of viewing television broadcasting. Specifically, display devices may be used in air, rail or bus or terminals, to inform passengers of information relating to the arrival and departure times of airplanes, trains or buses, or information relating to movies in theaters. If display devices are used in such a fashion, the same image is constantly displayed.

FIG. 1 is an exemplary view illustrating an image displayed on a display device.

In FIG. 1, an image 30 indicating the flight and departure time is displayed on a screen 20 of a display device 10. Such an image is continuously displayed without the image changing until the corresponding airplane leaves.

Although the residual image eliminating function of the conventional display device operates, residual image or burning phenomena are not sufficiently blocked due to the image properties. In other words, if a predetermined region continues to use the same color, as in image 30 of FIG. 1, the region has a pixel value similar to peripheral pixels even if the pixels shift slightly every a predetermined period. Therefore, the residual image eliminating function has little effect.

### SUMMARY OF THE INVENTION

Exemplary embodiments of the present invention overcome the above disadvantages and other disadvantages not described above. Also, the present invention is not required to overcome the disadvantages described above, and an exemplary embodiment of the present invention may not overcome any of the problems described above.

The present invention provides a device and a method for displaying an image in which the pixel output characteristics of pixels corresponding to a still image is newly adjusted if it is determined that at least one portion of the image is displayed as a still image even though the image is displayed according to the preset pixel output characteristics, so that burning or residual image phenomena can be effectively prevented.

According to an aspect of the present invention, there is provided an image display device comprising a display which displays an image according to preset pixel output characteristics; a motion detection part which detects motion of the displayed image; and an output controller which adjusts the pixel output characteristics of pixels corresponding to a still image if at least one portion of the image is determined to be a still image, based on the detection result of the motion detection unit.

The output controller may adjust the pixel output characteristics by increasing the pixel shift amount of a portion corresponding to the still image.

The output controller may adjust the pixel output characteristics by reducing the pixel shift cycle of a portion corresponding to the still image.

The output controller may adjust the pixel output characteristics by decreasing the luminance value of a portion corresponding to the still image.

The motion detection unit may comprise a divider which divides each frame constituting the image into a plurality of blocks; and a detector which checks the block matching state in each frame to detect blocks where there is no motion.

The output controller may comprises a determiner which determines whether at least one portion of the image is still based on the number of blocks detected by the detector and the total number of blocks, and outputs a control signal according to the determination result; and a signal processor which adjusts the pixel output characteristics of the pixels corresponding to the still image in response to the control signal.

The image display device may further comprise a storage unit which stores position information of the block detected by the detector. The output controller may comprise a determiner which determines an image corresponding to the detected block to be a still image, and outputs a control signal according to the determination result if it is determined that blocks in the same position of a predetermined number of frames do not represent motion by checking the position information of the detected block; and a signal processor which adjusts the pixel output characteristics of the pixels corresponding to the still image in response to the control signal.

The image display device may further comprise a timer which measures the time period during which at least one portion of the image is determined to remain still. The output controller may adjust the pixel output characteristics of the pixels corresponding to the still image, if the time period measured by the timer exceeds a preset threshold.

The image display device may further comprise an input unit which receives a user selection signal. The output controller may adjust the pixel output characteristics of the image if the user selection signal is not input for a preset period of time.

In the exemplary embodiment, the pixel output characteristics may be at least one of a pixel shift amount, a pixel shift direction, a pixel shift cycle, and a luminance value in order to prevent burning or residual image phenomena.

If the image display device further comprises a timer which measures the time period during which at least one portion of the image is determined to remain still, the output controller may selectively adjust one of the pixel shift amount, pixel shift direction, pixel shift cycle, and luminance value according to the length of the time period measured by the timer.

If the display device further comprises a timer which measures the time period during which at least one portion of the image is determined to remain still, the output controller may adjust one or more of the pixel shift amount, pixel shift direction, pixel shift cycle, and luminance value according to the length of the time period measured by the timer.

According to another aspect of the prevent invention, there is provided an image display method comprising displaying an image according to the preset pixel output characteristics; detecting a motion of the displayed image; and adjusting the pixel output characteristics of pixels corresponding to a still image and displaying the image, if at least one portion of the image is determined to be a still image based on the detection result.

The adjusting may comprise adjusting the pixel output characteristics by increasing the pixel shift amount of a portion corresponding to the still image.

The adjusting may comprise adjusting the pixel output characteristics by reducing the pixel shift cycle of a portion corresponding to the still image.

The adjusting may comprise adjusting the pixel output characteristics by decreasing the luminance value of a portion corresponding to the still image.

The detecting may comprise dividing each frame constituting the image into a plurality of blocks; and checking the block matching state in each frame to detect blocks where there is no motion.

The adjusting may comprise determining whether at least one portion of the image remains still based on the number of detected blocks and the total number of blocks; and signal-processing data corresponding to the still image and adjusting the pixel output characteristics if at least one portion of the image is determined to be a still image.

The image display method may further comprise storing position information of the detected block. The adjusting may comprise determining whether blocks in the same position of a predetermined number of frames do not represent motion, based on the position information; determining an image corresponding to blocks in the same position as a still image; and adjusting the pixel output characteristics of the pixels in the block corresponding to the still image.

The image display method may further comprise measuring the time period during which at least one portion of the image is determined to remain still. The adjusting may comprise adjusting the pixel output characteristics of the pixels corresponding to the still image if the measured time period exceeds a preset threshold.

The image display method may further comprise checking whether a user selection signal is input. The adjusting may comprise adjusting the pixel output characteristics of the image if the user selection signal is not input for a preset period of time.

In the exemplary embodiment, the pixel output characteristics may be at least one of a pixel shift amount, a pixel shift direction, a pixel shift cycle, and a luminance value in order to prevent burning or residual image phenomena.

If the display method further comprises measuring the time period during which at least one portion of the image is determined to remain still, the adjusting may comprise selectively adjusting one of the pixel shift amount, pixel shift direction, pixel shift cycle, and luminance value according to the length of the time period measured by the timer.

If the display method further comprises measuring the time period during which at least one portion of the image is determined to remain still, the adjusting may comprise adjusting one or more of the pixel shift amount, pixel shift direction, pixel shift cycle, and luminance value according to the length of the time period measured by the timer.

### BRIEF DESCRIPTION OF THE DRAWINGS

The above and/or other aspects of the present invention will be more apparent by describing certain exemplary embodiments of the present invention with reference to the accompanying drawings, in which:

FIG. 1 is an exemplary view of an image which may be displayed on a display device;

FIG. 2 is a block diagram illustrating a display device according to an exemplary embodiment of the present invention;

FIG. 3 is an exemplary view for explaining a method for adjusting the pixel output characteristics of the display device of FIG. 2;

FIGS. 4 and 5 are block diagrams illustrating display devices according to various exemplary embodiments of the present invention;

FIG. 6 is a flowchart explaining a display method according to an exemplary embodiment of the present invention;

FIG. 7 is a flowchart explaining a display method according to another exemplary embodiment of the present invention;

FIGS. 8 and 9 are flowcharts exemplarily explaining a method for determining whether an image is still according to the exemplary embodiments of the present invention; and

FIG. 10 a flowchart explaining a display method according to still another exemplary embodiment of the present invention.

### DETAILED DESCRIPTION OF THE EXEMPLARY EMBODIMENTS

Certain exemplary embodiments of the present invention will now be described in greater detail with reference to the accompanying drawings.

In the following description, same drawing reference numerals are used for the same elements even in different drawings. The matters defined in the description, such as detailed construction and elements, are provided to assist in a comprehensive understanding of the invention. Thus, it is apparent that the present invention can be carried out without those specifically defined matters. Also, well-known functions or constructions are not described in detail since they would obscure the invention with unnecessary detail.

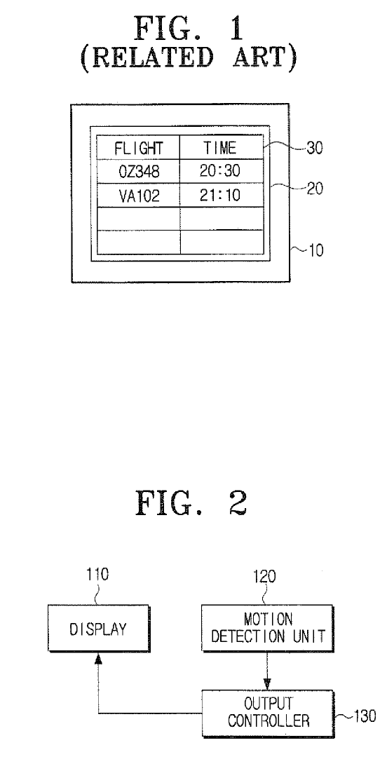

FIG. 2 is a block diagram illustrating a display device according to an exemplary embodiment of the present invention. In FIG. 2, the display device according to an exemplary embodiment of the present invention comprises a display 110, a motion detection unit 120, and an output controller 130.

The display 110 may comprise various display units such as a liquid crystal display (LCD) or a plasma display panel (PDP). Image display devices may be classified into LCD televisions (TVs) or monitors, and PDP TVs or monitors according to the type of display 110.

The display 110 displays an image based on the preset pixel output characteristics. The pixel output characteristics may comprise at least one of a pixel shift amount, a pixel shift cycle, a pixel shift direction, and a luminance value. Among these, the pixel shift amount, pixel shift cycle, and pixel shift direction relate to residual image eliminating functions. In other words, when pixels are shifted in order to eliminate the residual image, the pixel shift amount means the amount of pixels to be moved every shift. The pixel shift cycle refers to the period required to shift pixels, and the pixel shift direction indicates the direction in which the pixel moves. For example, if the pixel output characteristics are set in advance to make a pixel shift by one pixel every minute, the display 110 operates in such a fashion as to move pixels by one pixel in the fixed direction every minute while displaying the image. If the residual image eliminating function is inactive, the display 110 may only display an image based on a preset luminance value, while not performing the pixel shift.

The motion detection unit 120 detects a motion of an image displayed on the display 110. Generally, the motion detection is performed using known technologies, and more specifically, a block matching algorithm may be used. “Block matching algorithm” is a technique for detecting a motion in a fashion where each frame forming an image is fragmented into a plurality of blocks, the block-matching state between two continuous frames is determined, and the movement of matching blocks is checked. The motion detection may be performed for the whole image or for only a portion of the image, detailed description of motion detection will be provided below.

The output controller 130 controls the output state of the image on the display 110. Specifically, if the motion detection unit 120 determines that at least one portion of the image does not represent motion, the output controller 130 determines the portion without motion as a still image, and adjusts the pixel output characteristics of pixels corresponding to the portion determined to be a still image. As described above, the pixel output characteristics may be the pixel shift amount, pixel shift cycle, pixel shift direction, and luminance value.

In other words, if the portion is determined to be a still image, the pixel shift amount of the corresponding portion can be increased. For example, pixels are set to move by one pixel when displaying a general image, and thus the pixels shift by one pixel. However, from the time when the image is determined to be a still image, the pixel shift amount may be set to two or three pixels so that the pixels shift by two or three pixels.

Additionally, if the image is determined to be a still image while performing the pixel shift once every minute, pixel shift may be set to be performed once every 30 seconds and the shift direction may be set to be opposite to the original direction. Furthermore, the output controller 130 changes the luminance value to a value below the preset value, so that the pixels of the still image may be prevented from being damaged. The output controller 130 may control all or some of the characteristics described above. In addition, other characteristics relating to the pixel output may be added in addition to the above four characteristics.

Accordingly, the residual image eliminating function is utilized in a general image without any changes. However, the residual image of the still image may be strongly eliminated or the luminance value of the image may be reduced, and thus it is possible to effectively prevent burning or residual image phenomenon.

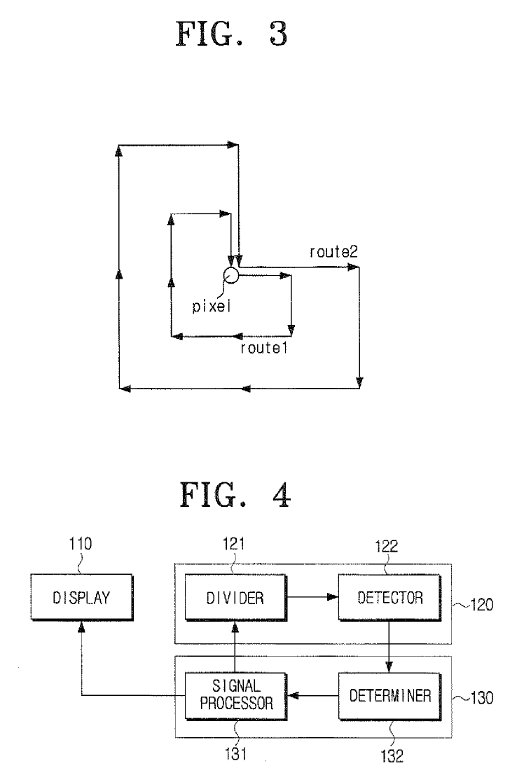

FIG. 3 is an exemplary view for explaining the case of adjusting the pixel shift amount as an example of a method for adjusting the pixel output characteristics of the display device of FIG. 2. In FIG. 3, the display 110 displays the image along route 1, based on the preset pixel output characteristics. Assuming that a single arrow indicates one pixel, the image moves right, down, left, left, up, up, right and down by one pixel every shift cycle, as shown in FIG. 3.

At this time, if the motion detection unit 120 detects a still image, the output controller 130 doubles the pixel shift amount of the pixels constituting the still image. Accordingly, as the pixel moves right, down, left, left, up, up, right and down by two pixels at a time, it is possible to effectively remove residual image or burning phenomena. The image moves by two pixels at a time in FIG. 3, but may also shift by one pixel at a time continuously in the same direction, that is, it may shift the right two pixels, down two pixels, left four pixels, up four pixels, right two pixels, and down two pixels.

FIG. 4 is a block diagram illustrating a display device according to one exemplary embodiment of the present invention. In FIG. 4, the motion detection unit 120 may comprise a divider 121 and a detector 122, and the output controller 130 may comprise a signal processor 131 and a determiner 132.

The signal processor 131 processes an image signal being received, and provides the processed signal to the display 110 to be displayed. The signal processing operation may comprise multiplexing, decoding, scaling, demultiplexing or other processing. As such operations are generally and widely known, detailed descriptions thereof will be omitted for the purpose of brevity.

The signal processor 131 sends the image signal to the divider 121. The divider 121 respectively divides frames constituting the image into a plurality of blocks. The term “block” means a contiguous set of pixels having the same width and height, that is, a set of M pixels horizontally and N pixels vertically. The “block” is usually referred to as a “macroblock”, and is generally indicated by M×N blocks.

The detector 122 compares each block, divided by the divider 121 using a block matching method, according to each frame, and detects a motion. The block matching method is used to compare two continuous frames, such as a previous frame and a current frame, by block units, and to estimate a motion based on the degree of matching of the signal type. According to the block matching method, the detector 122 computes the sum of absolute differences (SAD, sum of pixel values in blocks) of the blocks of the two continuous frames, and then compares the SAD to detect matching blocks. In other words, a block having a similar or identical SAD to the block on the previous frame is detected on a following frame. The SAD is obtained by the following Equation 1:

$$SAD = {\sum }_{i = 0}^{M - 1} {\sum }_{j = 0}^{N - 1} ( \vert {f}_{2} ( i , j ) - {f}_{1} ( i , j ) \vert ) \qquad [ Equation 1 ]$$

where, i and j represent coordinates of the pixel; f(i, j) represents the pixel value of the pixel placed at i×j; and a subscript of f indicates the corresponding frame.

If two matching blocks are in different positions, the detector 122 determines the corresponding block to be a non-still image, whereas if the blocks are in the same position, the detector 122 determines the corresponding block to be a still image. The detector 122 provides the determination result to the determiner 132.

The determiner 132 compares the total number of blocks to the number of blocks determined to form a still image, and determines whether the image is a still image. Specifically, if the ratio of blocks comprising the still image to all the blocks exceeds a predefined threshold, the whole image may be determined to be a still image.

If the blocks in the same position on several frames are determined to form a still image, a portion of the image may be determined to be a still image even though the ratio of blocks forming the still image to all the blocks is less than the predefined threshold.

The determiner 132 outputs a control signal corresponding to the determination result to the signal processor 131.

The signal processor 131 adjusts the pixel output characteristics in response to the control signal received from the determiner 132. In other words, if the whole image is determined to be a moving image and a control signal (for example, low pulse) corresponding to the determination result is input, the original pixel output characteristics are retained without any changes. On the other hand, if at least one portion of the image is determined to be a moving image and a control signal (for example, high pulse) corresponding to the determination result is input, the pixel output characteristics may be newly adjusted. As described above, the shift amount, time, direction and luminance value may be adjusted.

If only a portion of the image is the still image, the signal processor 131 may check position information of the still image and adjust the pixel output characteristics of only the corresponding portion. Specifically, if it is detected that the blocks in the same position of several frames do not represent motion constantly, the determiner 132 may provide position information of the corresponding block to the signal processor 131. For example, images representing the broadcasting station logo, time of day, and channel are constantly displayed in the same position, even if images excluding the above images are moving. Accordingly, only the specific region of the image is determined to be a still image. The signal processor 131 may adjust only a signal value of a segment corresponding to the corresponding block among vertical synchronizing signal segments constituting a single frame, using the position information output from the determiner 132.

The image signal processed by the signal processor 131 is transmitted to the display 110 to be displayed. Accordingly, the pixel output characteristics of the still image are adjusted, and thus, it is possible to obstruct burning or residual image phenomena.

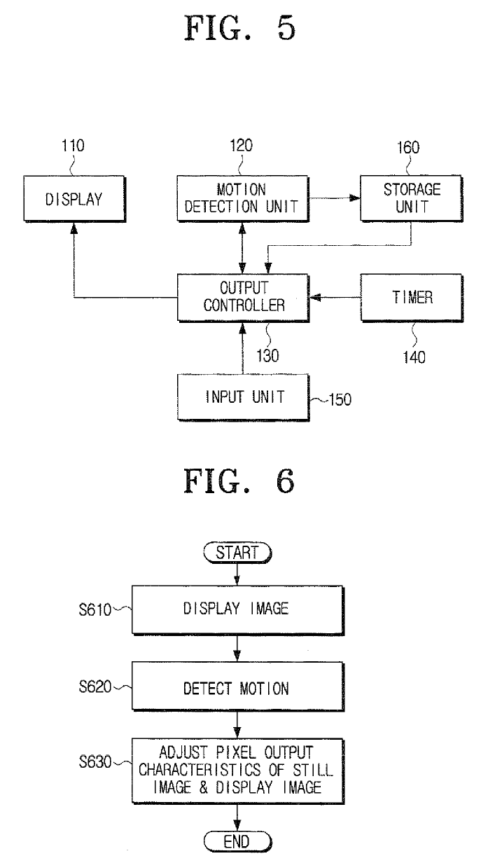

FIG. 5 is a block diagram illustrating a display device according to the other exemplary embodiment of the present invention. In FIG. 5, the display device according to another exemplary embodiment of the present invention comprises a timer 140, an input unit 150, and a storage unit 160, in addition to the display 110, motion sensor 120, and output controller 130. In this exemplary embodiment of the present invention, the display device comprising the timer 140, input unit 150, and storage unit 160 is illustrated, but a display device comprising only some of the aforementioned units may also be implemented.

The timer 140 measures the time period that elapses from when a still image is detected. If the motion detection unit 120 determines at least one portion of the image to be a still image, the output controller 130 operates the timer 140 to measure the time period. Accordingly, if the measured time exceeds a preset threshold (for example, 1 hour), the pixel output characteristics are adjusted. Therefore, the preset pixel output characteristics are applied to the still image displayed for a moment, without any changes.

The output controller 130 may permit the timer 140 to constantly measure also the time period that elapses after the pixel output characteristics are adjusted. Accordingly, if the adjusted pixel output characteristics are applied and a predetermined period of time (for example, 30 seconds) has elapsed again, the pixel output characteristics may be restored to their original settings.

The input unit 150 serves to receive a user selection signal. The user selection signal may be input through the use of a remote controller or a key pad mounted on a main body of the display device. If a specific key is entered, the input unit 150 transmits the user selection signal corresponding to the key to the output controller 130.

If the user selection signal is not input through the input unit 150 for a predetermined period of time, the output controller 130 may adjust the pixel output characteristics. Accordingly, even if a user does not actively use the display device, burning or residual image phenomena may be prevented.

The storage unit 160 stores position information of the block where the motion is not detected by the motion detection unit 120. If it is determined that at least one block of a single frame does not represent motion, the output controller 130 may store the position information of the corresponding block in the storage unit 160. The blocks of the previous frame in which the motion is not detected are compared with the blocks of the current frame, and a determination is made whether the motion is constantly detected in the same blocks. Therefore, it is possible to determine whether only a portion of the image is a still image.

A user may set the availability of the function to adjust the pixel output characteristics according to the exemplary embodiments of the present invention. The output controller 130 provides a user interface through the display 110, and accordingly the user can turn the above function on or off. Additionally, only the function to adjust the pixel output characteristics may be separately turned on or off according to whether the user selection signal is input through the input unit 150.

The output controller 130 may selectively adjust one of the pixel output characteristics or may adjust one or more pixel output characteristics according to the time period measured by the timer 140. In other words, four pixel output characteristics described above are applied successively according to the preset priority order, and thus the pixel output characteristics can be adjusted.

For example, if time t1 elapses after the still image is detected, the output controller 130 may adjust only the pixel shift direction. In this situation, if time t2 has elapsed, the output controller 130 may also adjust the pixel shift cycle while restoring the pixel shift direction to its original setting. Additionally, if time t3 has elapsed again, the output controller 130 may also adjust the pixel shift amount while restoring the pixel shift cycle to its original setting. Furthermore, if time t4 has elapsed again, the output controller 130 may also adjust the luminance value while restoring the pixel shift amount to its original setting. The adjustment order of the characteristics may be optionally set.

Alternatively, the output controller 130 may make one or more adjustments according to the elapsed time. In other words, the output controller 130 may adjust only the pixel shift direction during time period t1, and if time period t2 has elapsed, the output controller 130 may adjust not only the pixel shift direction but also the pixel shift cycle. If time period t3 has elapsed, the pixel shift amount may be adjusted in addition to the pixel shift direction and pixel shift cycle, and if time period t4 has elapsed, the luminance value may be adjusted together with the pixel shift direction, pixel shift cycle, and the pixel shift amount. Therefore, the adjustment criteria of the pixel output characteristics may change according to the stillness of the still image.

FIG. 6 is a flowchart explaining a display method according to an exemplary embodiment of the present invention. In FIG. 6, an image is displayed based on the preset pixel output characteristics (S610), and it is determined whether at least one portion of the image represents motion (S620). As a method for detecting a motion was described above, a detailed description thereof will be omitted for the purpose of brevity.

Accordingly, if the image is determined to be a still image where there is no motion, the pixel output characteristics are adjusted, and the image is then displayed (S630). As the pixel output characteristics and the adjustment method thereof were described above, detailed descriptions thereof will be omitted for the purpose of brevity.

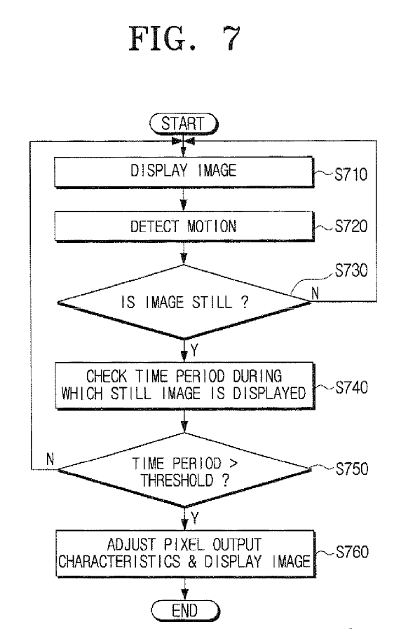

FIG. 7 is a flowchart explaining a display method according to another exemplary embodiment of the present invention. In FIG. 7, an image is displayed based on the preset pixel output characteristics (S710), and it is determined whether the image being displayed represents motion (S720).

If at least one portion of the image is determined to be a still image (S730:Y), the time period for which the still image is displayed is measured (S740). As a result, if it is determined that the time period exceeds a threshold (S750:Y), the pixel output characteristics are adjusted and the image is displayed (S760). On the other hand, if it is determined that the time period is less than a threshold (S750:N), the image is displayed while constantly detecting the motion, under the state where the original pixel output characteristics are retained without any changes (S710 and S720). If at least one portion of the image is determined to be a moving image (S730:N), the image is displayed while constantly detecting the motion, under the state where the original pixel output characteristics are retained without any changes (S710 and S720).

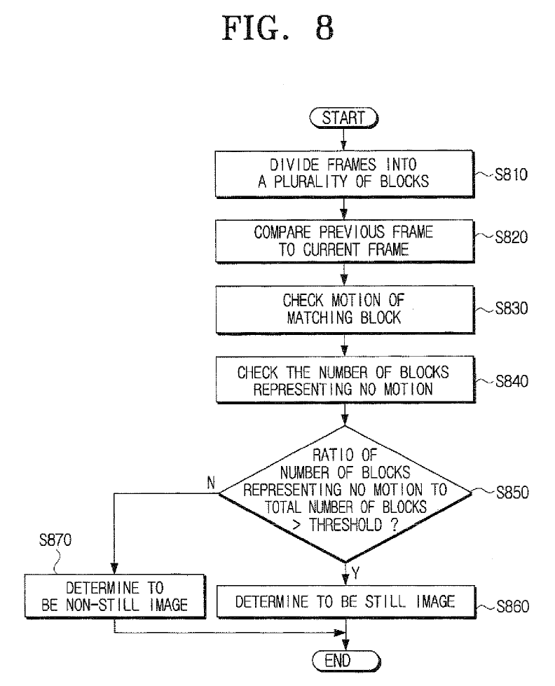

FIG. 8 is an exemplary flowchart explaining a method for determining whether the image is a still image. In FIG. 8, frames constituting the image are divided into a plurality of blocks (S810), and a previous frame is compared to a current frame (S820).

Next, a matching block is found between two frames, and the position of the block is checked to determine whether the block represents a motion (S830). Specifically, if a block (a, b) in the previous frame matches the block (a, b+2) in the current frame, the corresponding block may move downward by about two blocks.

In this way, the number of blocks which do not represent motion between the previous frame and current frame is checked (S840).

The ratio of the number of blocks where there is no motion to the total number of blocks is obtained, and a determination is made whether the ratio exceeds a threshold (S850). If the ratio exceeds a threshold (S850:Y), the whole image is determined to be a still image (S860), but, on the other hand, if the ratio is less than a threshold (S850:N), the whole image is determined to be a moving image (S870).

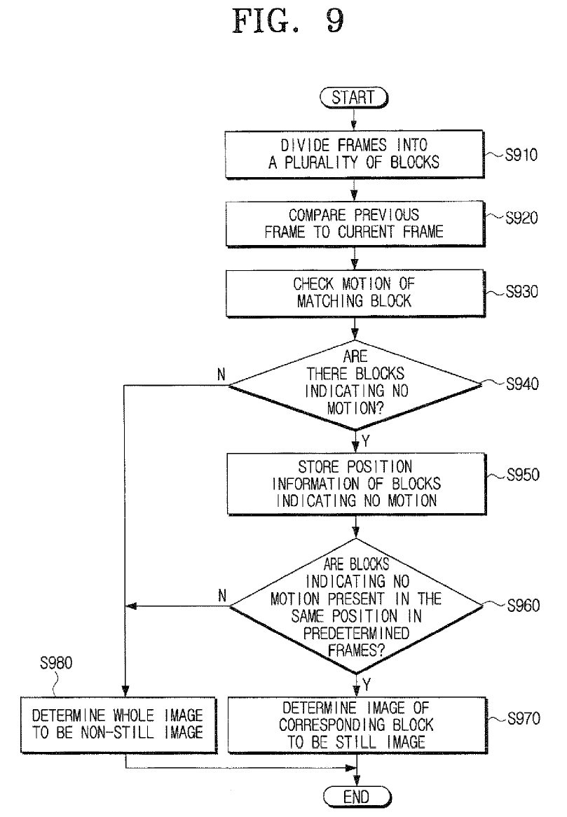

FIG. 9 is another exemplary flowchart explaining a method for determining whether the image is a still image. In FIG. 9, frames are divided into a plurality of blocks (S910), and the previous frame is compared to the current frame (S920). As a result of comparing, if a matching block is detected between the previous and current frames, a determination is made whether the corresponding block represents motion (S930).

Accordingly, if it is determined that there are no blocks where there is no motion (S940:N), the whole image is determined to be a moving image (S980). Additionally, even if the number of blocks where there is no motion is less than the preset number, the whole image may be determined to be a non-still image.

If the number of blocks where there is no motion is equal to or greater than the preset number (0 or positive integer) (S940:Y), the position information of the blocks is stored (S950).

Next, using the previously stored position information, a determination is made whether the blocks where there is no motion are present in the same position in a preset number of frames (S960). If the blocks are not present (S960:N) as a result of determining, the whole image is determined to be a moving image (S980).

n the other hand, if the blocks are present in the same position (S970:Y), the image corresponding to the blocks is determined to be a still image (S970). Accordingly, it is possible to find whether a portion of the image is still.

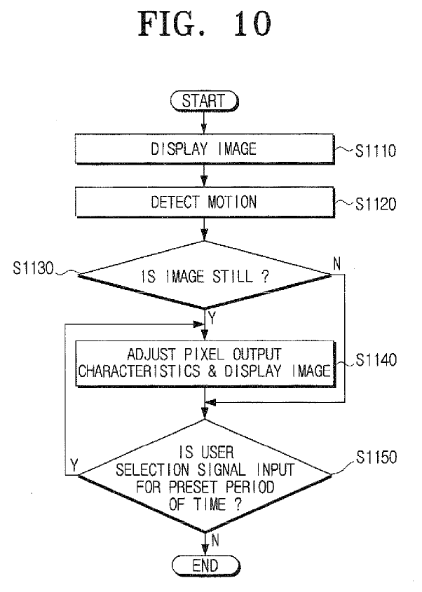

FIG. 10 is a flowchart explaining a display method according to still another exemplary embodiment of the present invention. In FIG. 10, an image is displayed based on the preset pixel output characteristics (S1110). A motion of each frame is detected (S1120), and it is determined whether the image is still (S1130). If the image is determined to be a still image, the pixel output characteristics are newly adjusted (S1140), whereas if the image is determined to be a moving image, the original pixel output characteristics are retained without any changes.

Subsequently, it is determined whether the user selection signal is input for the preset threshold (S1150). If the user selection signal is input for the preset time, the current state is maintained without any changes, and on the other hand if the user selection signal is not input for the preset time, the pixel output characteristics are adjusted. Therefore, when the still image is constantly displayed or a user does not use the display device, the pixel output characteristics are automatically adjusted to prevent burning or residual image phenomena.

As described above, according to the exemplary embodiments of the present invention, the pixel output characteristics are appropriately controlled according to whether the image is still, so that the screen burning phenomenon or the residual image problem can be effectively obstructed. Particularly, screen burning or residual image phenomena can also be prevented from occurring even when the residual image eliminating function is operated. Additionally, when the user does not actively use the display device, the pixel output characteristics are adjusted to prevent the screen from being damaged.

The foregoing exemplary embodiments and advantages are merely exemplary and are not to be construed as limiting the present invention. The present teaching can be readily applied to other types of apparatuses. Also, the description of the exemplary embodiments of the present invention is intended to be illustrative, and not to limit the scope of the claims, and many alternatives, modifications, and variations will be apparent to those skilled in the art.

What is claimed is:

1. An image display device comprising:
a display which displays an image according to preset pixel output characteristics;
a motion detection unit which detects motion of the displayed image; and
an output controller which adjusts the preset pixel output characteristics of pixels of the image if at least one portion of the image is determined to be still, based on a detection result of the motion detection unit.

2. The apparatus as claimed in claim 1, wherein the output controller adjusts the preset pixel output characteristics by increasing a pixel shift amount of the at least one portion of the image determined to be still.

3. The apparatus as claimed in claim 1, wherein the output controller adjusts the preset pixel output characteristics by reducing a pixel shift cycle of the at least one portion of the image determined to be still.

4. The apparatus as claimed in claim 1, wherein the output controller adjusts the preset pixel output characteristics by decreasing a luminance value of the at least one portion of the image determined to be still.

5. The apparatus as claimed in claim 1, wherein the motion detection unit comprises:
a divider which divides a frame of the image into a plurality of blocks; and
a detector which checks a block matching state in the frame to detect a block where there is no motion.

6. The apparatus as claimed in claim 5, wherein the output controller comprises:
a determiner which determines whether the at least one portion of the image is still based on a number of blocks detected by the detector and a total number of blocks to generate a determination result, and outputs a control signal according to the determination result; and
a signal processor which adjusts the preset pixel output characteristics of the pixels corresponding to the at least one portion of the still image in response to the control signal.

7. The apparatus as claimed in claim 5, further comprising:
a storage unit which stores position information of the detected block,
wherein the output controller comprises:
a determiner which determines an image corresponding to the detected block to be still to generate a determination result, and outputs a control signal based on the determination result, if blocks in a same position in a number of frames do not indicate motion based on information of the same position of the detected block; and
a signal processor which adjusts the preset pixel output characteristics of the pixels corresponding to the still image in response to the control signal.

8. The apparatus as claimed in claim 1, further comprising a timer which measures a time period during which the at least one portion of the image remains still,
wherein the output controller adjusts the preset pixel output characteristics of the pixels corresponding to the image determined to be still, if the time period measured by the timer exceeds a preset threshold.

9. The apparatus as claimed in claim 1, further comprising an input unit which receives a selection signal,
wherein the output controller adjusts the preset pixel output characteristics of the image, if the selection signal is not input for a preset period of time.

10. The apparatus as claimed in claim 1, wherein the preset pixel output characteristics comprise at least one of a pixel shift amount, a pixel shift direction, a pixel shift cycle, and a luminance value.

11. The apparatus as claimed in claim 10, further comprising a timer which measures a time period during which the at least one portion of the image remains still,
wherein the output controller selectively adjusts one of the pixel shift amount, the pixel shift direction, the pixel shift cycle, and the luminance value based on the time period measured by the timer.

12. The apparatus as claimed in claim 10, further comprising a timer which measures a time period during which the at least one portion of the image remains still,
wherein the output controller adjusts one or more of the pixel shift amount, the pixel shift direction, the pixel shift cycle, and the luminance value based on the time period measured by the timer.

13. An image display method comprising:
displaying an image according to preset pixel output characteristics;
detecting a motion of the displayed image; and
adjusting the preset pixel output characteristics of pixels of at least one portion of the image and displaying the image, if the at least one portion of the image is determined to be still based on a detection result.

14. The method as claimed in claim 13, wherein the adjusting comprises adjusting the preset pixel output characteristics by increasing a pixel shift amount of the at least one portion of the image determined to be still.

15. The method as claimed in claim 13, wherein the adjusting comprises adjusting the preset pixel output characteristics by reducing a pixel shift cycle of the at least one portion of the image determined to be still.

16. The method as claimed in claim 13, wherein the adjusting comprises adjusting the preset pixel output characteristics by decreasing a luminance value of the at least one portion of the image determined to be still.

17. The method as claimed in claim 13, wherein the detecting comprises:
dividing a frame of the image into a plurality of blocks; and
checking a block matching state in the frame to detect a block where there is no motion.

18. The method as claimed in claim 17, wherein the adjusting comprises:
determining whether the at least one portion of the image is still, based on a number of detected blocks and a total number of blocks; and
signal-processing data corresponding to the at least one portion of the still image and adjusting the preset pixel output characteristics of pixels of the image if the at least one portion of the image is still.

19. The method as claimed in claim 17, further comprising storing position information of the detected block,
wherein the adjusting comprises:
determining whether blocks in a same position in a number of frames do not indicate motion, based on the position information;
determining an image corresponding to the blocks in the same position to be still; and
adjusting the preset pixel output characteristics of the pixels in the blocks corresponding to the still image.

20. The method as claimed in claim 13, further comprising measuring a time period during which the at least one portion of the image remains still,
wherein the adjusting comprises adjusting the preset pixel output characteristics of the pixels corresponding to the image determined to be still if the measured time period exceeds a preset threshold.

21. The method as claimed in claim 13, further comprising checking whether a selection signal is input,
wherein the adjusting comprises adjusting the preset pixel output characteristics of the image if the selection signal is not input for a preset period of time.

22. The method as claimed in claim 13, wherein the preset pixel output characteristics comprise at least one of a pixel shift amount, a pixel shift direction, a pixel shift cycle, and a luminance value.

23. The method as claimed in claim 22, further comprising measuring a time period during which the at least one portion of the image remains still,
wherein the adjusting comprises selectively adjusting one of the pixel shift amount, the pixel shift the direction, the pixel shift cycle, and the luminance value based on the time period measured by the timer.

24. The method as claimed in claim 22, further comprising measuring a time period during which the at least one portion of the image remains still,
wherein the adjusting comprises adjusting one or more of the pixel shift amount, the pixel shift direction, the pixel shift cycle, and the luminance value based on the time period measured by the timer.
